(19) United States
(12) Patent Application Publication
(10) Pub. No.: US 2007/0119092 A1
(43) Pub. Date: May 31, 2007

(54) Fishing hook and method for attaching a snell to a fishing hook

(76) Inventor: Jeff A. Gruber, Dubuque, IA (US)

Correspondence Address: LITMAN LAW OFFICES, LTD., P.O. BOX 15035, CRYSTAL CITY STATION, ARLINGTON, VA, 22215, US

(21) Appl. No.: 11/604,273

(22) Filed: Nov. 27, 2006

Related U.S. Application Data
(60) Provisional application No. 60/740,269, filed on Nov. 29, 2005.

(51) Int. Cl. A01K 83/00

(52) U.S. Cl. 43/44.83; 43/43.16

(57) ABSTRACT

The fishing hook has a shank, a pointed hook portion formed at the lower end of the shank, and an eyelet formed at the upper end of the shank. The eyelet is formed by a generally D-shaped open loop that defines a cleft at the apex of the eyelet. The method of attaching a snell (a short leader line) to a fishing hook includes the steps of: forming a loop in a snell; passing the loop through the eyelet; rotating the fishing hook at least one full rotation to twist the loop; passing the loop over the open end of the eyelet; and pulling the snell to form a knot at the apex of the eyelet.

### CROSS-REFERENCE TO RELATED APPLICATION

This application claims the benefit of U.S. Provisional Patent Application Ser. No. 60/740,269, filed Nov. 29, 2005.

### BACKGROUND OF THE INVENTION

1. Field of the Invention

The present invention relates to equipment for catching fish, and more particularly to fishing hooks.

2. Description of the Related Art

Fishing hooks typically consist of a shank with a hook extending from the lower portion of the shank. An eyelet is provided at the upper end of the shank for attaching a fishing line to the hook.

Fishermen using conventional hook designs encounter a number of problems. The first problem is the issue of securing a fishing line or a leader line to the hook. It is important that the line be firmly secured to the hook so that a fish, once hooked, does not escape by pulling the hook free from the line. A number of knots for securing the line to conventional fish eyelets are known, but many conventional knots are difficult to tie properly, particularly when the user is wearing gloves, or if the user's manual dexterity is impaired from exposure to the cold weather which users often find conducive to catching fish. Improperly tied knots can result in the line becoming detached from the hook, causing a loss of the fishing tackle, attached bait, or even a fish escaping after being hooked.

Another issue with conventional hooks involves hazards presented when attempting to remove a fish from the hook once the fish is caught. Conventional fishhooks are made of strong wire, the hook end of which may have a sharp edge. When a user attempts to grip the eyelet of a hook to free a live fish, the movements of the struggling fish may cause the sharp edge from the hook to cut into the hands and fingers of the user. Further, conventional fishing hooks are often difficult to extract from a fish's mouth because the fish may swallow the hook, thus leaving only a small upper portion of the eyelet for the user to grasp while attempting to pull and work the hook free from the fish.

Ideally, a fishing hook provides “lever action” to assist in hooking the fish. Lever action is the tendency for the force exerted on the line attached to the hook to drive the hook into the fish. Lever action results from the line of force generated through a tug on the fishing line acting along the line of the point of the hook, so that pulling on the line tends to drive the hook point into the fish. When a line is knotted or tied to the eyelet of the conventional fishing hook, the securing knot may slide around the circumference of the eyelet. The result is that the line of force along the fishing line may deviate from the line of action of the hook portion of the fishing hook, eliminating the desired lever action and increasing the risk that the fish may escape.

Japanese Patent No. 6-327,378, published Nov. 29, 1994, shows, in FIG. 1, a fishing hook with an eyelet having a substantially square shape and an offset medial portion of the shank. German Patent No. 19,944,944, published Apr. 5, 2001, shows a plurality of fishing hooks having a medial loop in the shank.

Thus a fishing hook solving the aforementioned problems is desired.

### SUMMARY OF THE INVENTION

The fishing hook has a shank, a pointed hook portion formed at the lower end of the shank, and an eyelet formed at the upper end of the shank. The eyelet is formed by a generally D-shaped open loop. In some embodiments the eyelet is closed by braising or the like. In other embodiments, the end of the loop may be separated from the shank by a small gap when aligned to one side of the plane of the hook portion (referred to as an open position), and biased into contact with the shank by spring tension when aligned to the opposite side of the plane of the hook portion (referred to as the closed portion. In some embodiments, the end of the loop may be blunted by attachment of a blunt tip or by forming a smaller loop at the end of the D-shaped open loop. The eyelet has a downwardly facing cleft in which the knot for a leader line lodges to provide leverage for setting the hook in the fish when the line is pulled, and the D-shape provides a broad structure to grab when removing the hook from the fish.

The open loop forming the eyelet permits a novel way of tying a knot to secure a leader line or snell (as used in the present application, the term “snell” is defined as a length of fine, threadlike material, such as monofilament or gut, that connects a fishing hook to a fishing line, i.e., a snell is a short length of leader line) to the hook. The method of attaching a snell to a fishing hook includes the steps of: forming a loop in a snell; passing the loop through the eyelet; rotating the fishing hook at least one full rotation to twist the loop; passing the loop over the open end of the eyelet; and pulling the snell to form a knot at the apex of the eyelet.

The fishing hook and method for attaching the snell allows for relatively fast and easy placement of one or more of such fishing hooks on a fishing line, and allows for easy visual identification, by a fisherman or the like, of the position of the hook point within the mouth of a hooked fish. As will be described in further detail below, the present invention includes a hook point indicator, allowing the fisherman to easily discern the position of the hook point with respect to the eyelet; i.e., the hook point indicator allows the fisherman to determine the direction of the bend at the bottom of the hook with respect to the eyelet.

These and other features of the present invention will become readily apparent upon further review of the following specification and drawings.

### BRIEF DESCRIPTION OF THE DRAWINGS

FIG. 1 is an environmental perspective view of a first embodiment of a fishing hook according to the invention with a line attached to the eyelet.

FIG. 2A is a side perspective view of the fishing hook of FIG. 1.

FIG. 2B is a front perspective view of the fishing hook of FIG. 1 with the eyelet aligned in an open position.

FIG. 2C is a front perspective view of the fishing hook of FIG. 1 with the eyelet closed by spring tension.

FIGS. 3A, 3B, 3C, 3D and 3E are side views showing successive stages of attaching a snell to the fishing hook of FIG. 1.

FIG. 4 is a side view of a second embodiment of a fishing hook according to the present invention having a permanently closed eyelet.

FIG. 5 is an environmental side view of a third alternative embodiment of a fishing hook according to the present invention with an attached swivel.

FIG. 6 is a side view of a fourth alternative embodiment of a fishing hook according to the present invention having a barbed shank.

FIG. 7 is a side view of a fifth embodiment of a fishing hook according to the present invention having a flag-shaped eyelet.

FIG. 8 is a side view of a sixth embodiment of a fishing hook according to the present invention with a latching closable eyelet.

FIG. 9 is a side view of a seventh embodiment of a fishing hook according to the present invention having a lead jig.

FIG. 10 is a side view of an eighth embodiment of a fishing hook according to the present invention with a swivel attachment loop.

FIG. 11 is a side view of a ninth alternative embodiment of a fishing hook according to the invention with a blunted eyelet end.

Similar reference characters denote corresponding features consistently throughout the attached drawings.

### DETAILED DESCRIPTION OF THE PREFERRED EMBODIMENTS

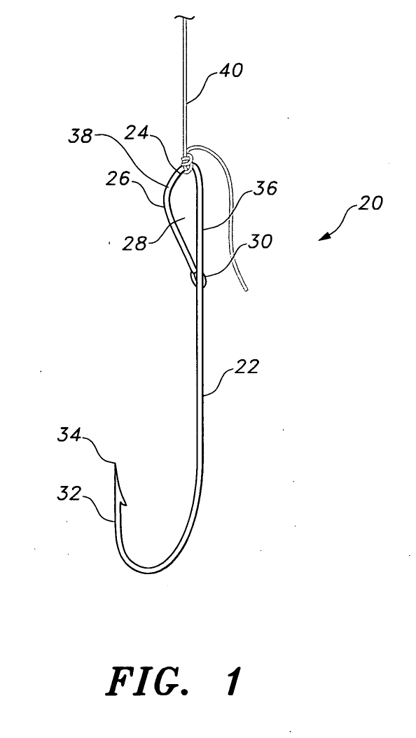

The present invention is a fishing hook and a method for attaching a snell a line to the fishing hook. Referring first to FIG. 1, features of the fishing hook may be appreciated.

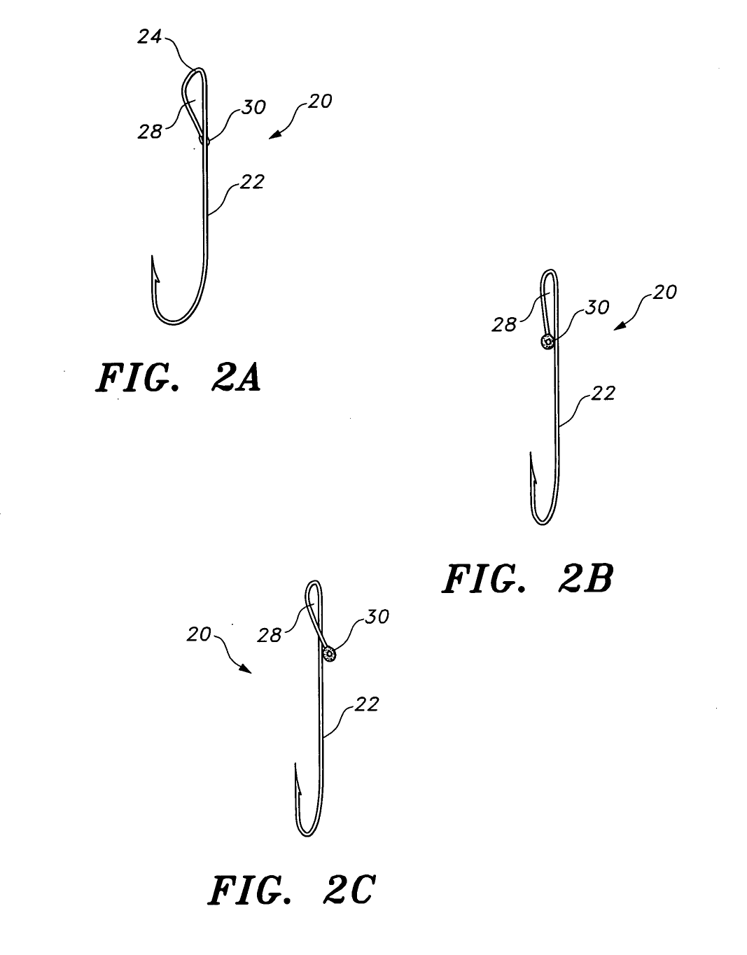

The fishing hook 20 is preferably formed from a relatively strong metal wire. The fishing hook 20 includes a shank 22. The lower end of the shank 22 is bent to form a hook portion 32 that comes to a barbed point 34. The upper portion of the shank 22 is preferably bent to form a D-shaped eyelet 26 defining an eyelet opening 28 with a cleft 24 (best shown in FIG. 2A) at the apex of the eyelet 26. The D-shaped eyelet 26 is formed by a rectilinear extension 36 of the shank and an arcuate leg 38 that curves downward and outward from the apex of the eyelet 26 towards the point 34 of the hook portion 32 and then back towards the shank 22. A leader line or snell 40 is attached to the fishing hook 20 with a knot that lodges in the cleft 24 of the eyelet 26. The cleft 24 maintains the position of the knot in the eyelet so that a force pulling on the leader line or snell 40 operates along the axis of the shank 22, generating lever action to aid in setting the hook portion 32 into a fish.

The D-shaped eyelet 26 is preferably an open loop. The end of the shank 22 forming the eyelet 26 may be blunted by being bent into a small closed loop 30 at the end of arcuate leg 38, by fastening a blunt tip to the end of the eyelet, by peening or flattening the end of the eyelet 26, or by any other means. By looping the end of the wire into the shank 22, the exposed end of the wire is covered, thus mitigating the risk of the end of the wire cutting into the hand of a user. The formed eyelet 26 can be used as a handle to hold onto the fishing hook 32 while extracting the hook portion 32 from a fish. The relatively large area enclosed by the eyelet circumference forms an impediment against swallowing of the entire hook by a fish, ensuring that a user can readily grasp the fishing hook 20 to remove the hook 20 from a fish.

By referring to FIGS. 2A, 2B, and 2C, additional details of the eyelet 26 may be appreciated. FIGS. 2A and 2B show the eyelet 26 in an open position. The closed looped end 30 of the wire forming the eyelet 26 is aligned to pass to one side of the shank 22, forming a small gap between the loop 30 at the end of the eyelet 26 and the shank 22. The bend forming the circumference of the eyelet 26 is biased to maintain the formed gap, keeping the eyelet 28 open. As shown in FIG. 2C, the eyelet opening may be closed by moving the closed loop 30 to the opposite side of the plane of the shank 22 and hook portion 32, so that spring bias holds the eyelet 28 closed with the arcuate leg 38 bearing against the shank 22.

As further illustrated in FIGS. 2B and 2C, the closed loop portion 30 may be colored, textured or otherwise visually marked, through the use paint, ink, dye or any other suitable visual marking method. This allows the fisherman to easily identify the location and angle of the fishing hook within the fish's mouth following hooking of the fish with respect to the eyelet portion; i.e., the hook point indicator allows the fisherman to determine the direction of the bend at the bottom of the hook with respect to the eyelet.

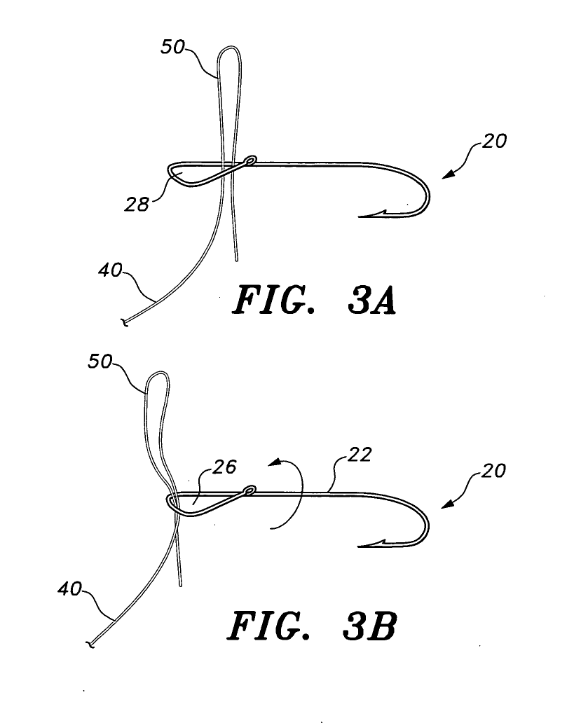

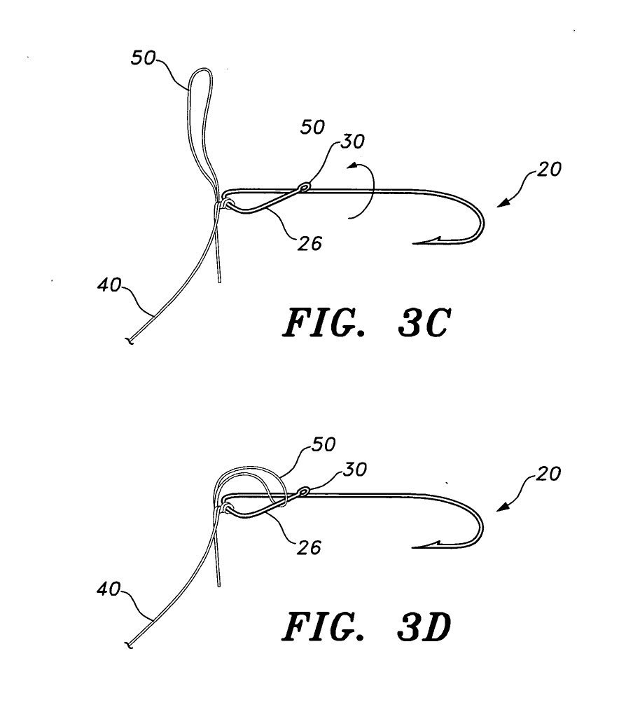

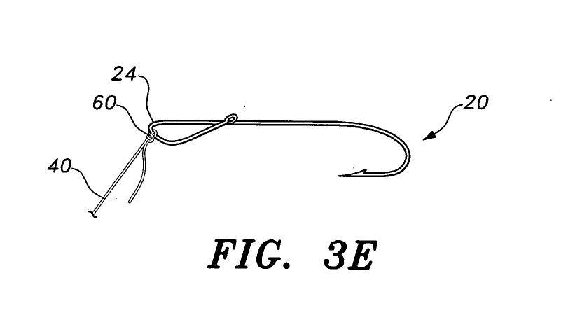

A method of attaching a snell (a short length of leader line) to the fishing hook 20 is described by referring to FIGS. 3A, 3B, 3C, 3D and 3E. Referring first to FIG. 3A, a loop 50 is formed in the end of the snell 40. The loop is passed through the eyelet opening 28. Next, as shown in FIG. 3B, the fishing hook 20 is rotated through one or more rotations about an axis collinear with the shank 22 of the fishing hook 20. Preferably, the fishing hook 20 is only rotated once, as multiple full revolutions will result in a weaker knot. The rotations cause the loop 50 to form twists above the wire defining the eyelet 26 of the fishing hook 20 adjacent the cleft 24, as shown in FIG. 3C.

Next, as may be appreciated in FIG. 3D, with the eyelet 26 in the open position, as described above with reference to FIG. 2B, the end of the loop 50 is passed over the end 30 of the eyelet. Finally, as shown in FIG. 3E, by pulling on the end of the fishing line 40, the snell 40 is drawn into a knot 60 next to cleft or apex 24, which is then snugly positioned into the cleft 24 of the eyelet opening 28 through manual force being applied to either the snell 40 and/or the fishing hook 20. Once the knot 60 is formed, the eyelet 26 may be closed as described above with reference to FIG. 2C.

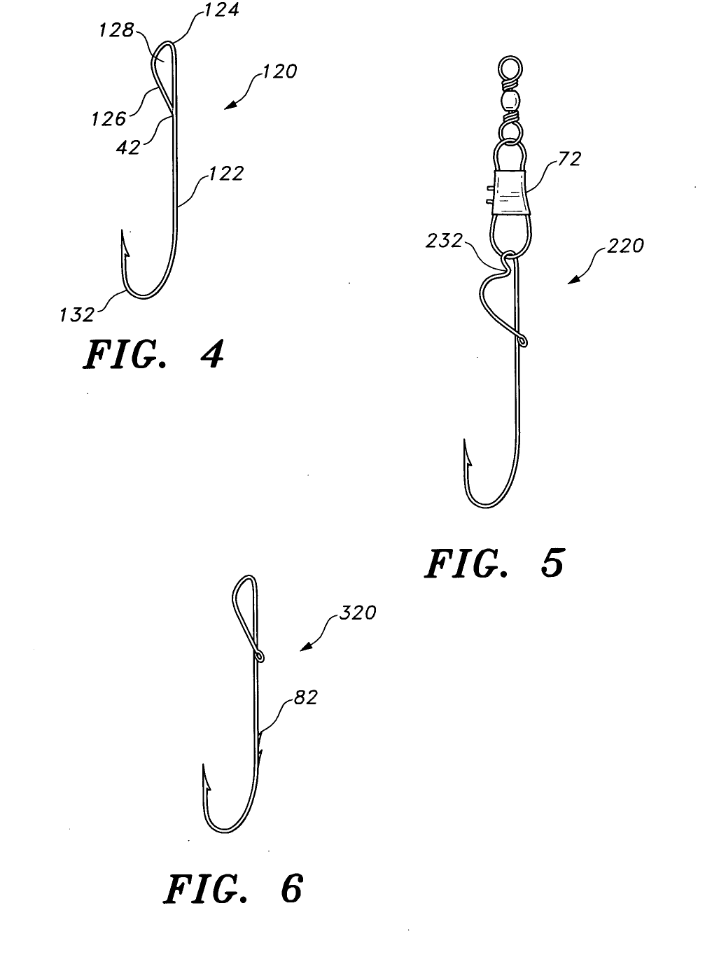

Variations on the fishing hook may be appreciated by referring to FIGS. 5, 6, 7, 8, 9, and 10.

FIG. 5 illustrates a selectively openable and closable eyelet fishing hook 220 with an eyelet adapted to accommodate a snap swivel 72. The shank, and hook portion of the fishing hook 220 are of identical construction to the fishing hook 20 described above with reference to FIG. 1. However, the latchable eyelet has a second bend 232 below the apex of the eyelet. The second bend forms a notch that prevents the swivel catch 72 from moving within the eyelet to a position out of line with the shank, the cleft being defined within the notch.

FIG. 6 illustrates a selectively openable and closable eyelet fishing hook 320 having an eyelet formed identically to the fishing hook described with reference to FIG. 1. The shank of the fishing hook 320, in this embodiment, is provided with additional shank barbs 82.

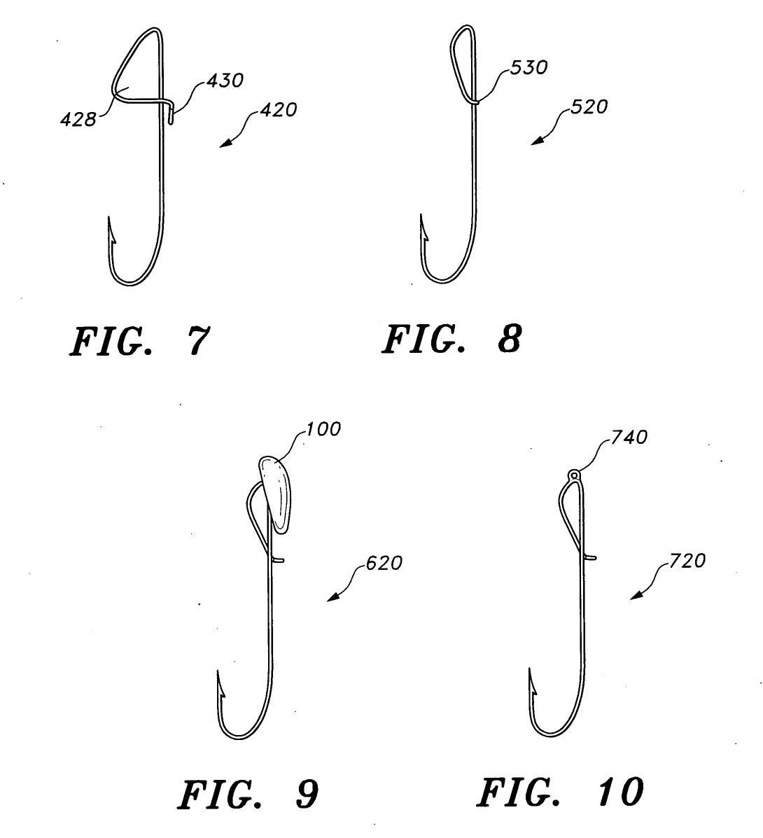

The fishing hook 420 illustrated in FIG. 7 is a selectively openable and closable eyelet fishing hook with a flag-shaped opening 428. The eyelet again has a cleft at the apex of the eyelet, as described above. However, the lower portion of the eyelet is widened to produce a flag-shaped eyelet, providing an enhanced impediment to being swallowed by a hooked fish. The wire of the end loop 430 of the eyelet is bent substantially downward so that the end loop 430 is positioned approximately parallel to the shank. The bent closing loop provides an additional impediment to being swallowed by a hooked fish.

FIG. 8 illustrates a latchable selectively openable and closable eyelet fishing hook 520 having a selectively openable and closable eyelet, shank, and hook portion of similar construction to the fishing hook 20 described above with reference to FIG. 1. As will be described below with reference to FIG. 11, the latchable eyelet, and variations thereof, may further be used to hold bait to the fishing hook. The latchable eyelet fishing hook 520 differs from the fishing hook of FIG. 1 in that the loop 530 at the end of the wire is not closed, but is open and has a gap wide enough to allow the shank to slip within the circumference of the loop 530, thereby hooking the eyelet closed. When the loop encircles the shank, the eyelet of the fishing hook 520 is latched closed.

FIG. 11 illustrates an alternative embodiment of the fish hook 920, which is similar to fish hook 520 of FIG. 8, except that the loop portion 530 is replaced with a relatively flat catch member 930, which catches on the shaft of the fish hook in the closed position. This configuration allows for the positioning of bait (illustrated in FIG. 11 in dashed line as an exemplary worm) on both the upper portion of the fish hook and the lower portion of the hook, as shown. It will be noted that other embodiments of the fishing hook may also be formed with the free end of the arcuate leg 38 crossing the shank 22 and extending beyond the medial portion of the shank 22, the blunted end of the eyelet 26 preventing puncture of the fingers.

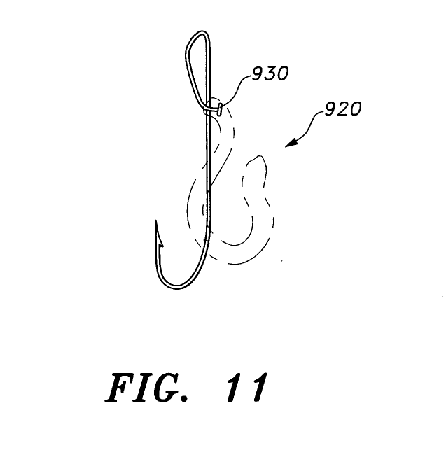

FIG. 9 illustrates a weighted selectively openable and closable eyelet fishing hook 620 having a selectively openable and closable eyelet, shank, and hook portion of identical construction to the fishing hook 20 described above with reference to FIG. 1. A jig 100 made of lead or other dense material is affixed to the eyelet.

FIG. 10 illustrates a selectively openable and closable eyelet fishing hook 720 having a selectively openable and closable eyelet, shank, and hook portion of identical construction to the fishing hook 20 described above with reference to FIG. 1. The fishing hook 720 is additionally provided with a swivel attachment loop or conventional closed eyelet 740 located at the apex of the selectively openable and closable eyelet. A snap swivel may be attached to the closed eyelet 740.

A closed eyelet fishing hook in accordance with the invention is described with reference to FIG. 4. The closed eyelet fishing hook 120 is formed from a stiff, resilient wire. The closed eyelet fishing hook 120 comprises a shank 122. The lower portion of the shank 122 is bent into a hook portion 132. The upper portion of the shank 122 is bent at an acute angle to form an eyelet opening 128 with a cleft 124 at the apex of the eyelet. The cleft 124 maintains the position of fishing line secured to the eyelet 126 so that the a force pulling on the line operates along the line of the shank 122, generating lever action to aid in setting the hook portion 132 into a fish.

The end 42 of the wire forming the eyelet is attached to the shank 122 by braising, welding, or other permanent means, resulting in a closed eyelet 126. The eyelet opening 126 provides a handle for grasping the fishing hook 120 when removing the hook from a fish, and provides an impediment against swallowing of the fishing hook 120 by a fish.

Additionally, the enlarged eyelet opening provides for greater structural strength than the relatively small eyelets provided in conventional fish hooks. By tying the end of the fishing line about cleft 24 of the enlarged D-shaped opening 28, the upper portion of the fish hook (forming the eyelet opening) may take an increased force load (produced by the fishing line) without deforming. In order to enhance the load-bearing properties of a conventional fishing hook, the upper portion forming the eyelet opening would have to be thickened or otherwise structurally enhanced from its present configuration.

It is to be understood that the present invention is not limited to the embodiments described above, but encompasses any and all embodiments within the scope of the following claims.

I claim:

1. A fishing hook comprising:
a shank portion having an upper portion, a lower portion, and a medial portion between the upper and lower portions;
a hook portion formed at the lower portion of the shank, the hook portion terminating in a point; and
an eyelet formed from the upper portion of the shank, the eyelet being substantially D-shaped, the D-shaped eyelet having a first leg formed by a rectilinear extension of the medial portion of the shank and an arcuate second leg curving downward toward the hook and back towards the medial portion of the shank, the eyelet having an apex defining a cleft.

2. The fishing hook as recited in claim 1, wherein the eyelet forms a closed loop, the arcuate leg having an end permanently joined to the medial portion of the shank.

3. The fishing hook as recited in claim 1, wherein the eyelet forms an open loop, the arcuate leg of the eyelet having a free end.

4. The fishing hook according to claim 3, wherein the arcuate leg is separated from the shank by a small gap, defining an open position, when the arcuate leg is aligned on a first side of a plane defined by the shank and the hook portion, and is movable to a closed position in which the arcuate leg is held against the shank by spring tension upon a side of the plane opposite the first side.

5. The fishing hook according to claim 3, wherein the free end of the arcuate leg is blunted in order to avoid puncture wounds when handling the fishing hook.

6. The fishing hook as recited in claim 3, wherein the free end of the arcuate leg is formed into a closed loop.

7. The fishing hook as recited in claim 3, further comprising means for visually indicating and locating the free end of said arcuate leg.

8. The fishing hook as recited in claim 3, wherein the arcuate leg defines a notch at the apex of the eyelet for retaining a snap swivel.

9. The fishing hook as recited in claim 3, further comprising a plurality of barbs disposed on the shank.

10. The fishing hook as recited in claim 3, further comprising a jig formed on the eyelet.

11. The fishing hook as recited in claim 3, wherein the free end of said arcuate leg defines an open loop dimensioned and configured to hook onto the medial portion of the shank for latching the eyelet closed.

12. The fishing hook as recited in claim 3, further comprising a closed loop disposed above the apex of said eyelet for attachment of a snap swivel.

13. A method of attaching a snell to a fishing hook, the fishing hook having a D-shaped eyelet the eyelet having an apex defining a cleft and having a free end, the method comprising the steps of:
forming a loop in the snell;
passing the loop through the eyelet;
rotating the fishing hook at least one full rotation to twist the loop;
passing the loop over the free end of the eyelet; and
pulling the snell to form a knot in the cleft at the apex of the eyelet.
